(19) United States
(12) Patent Application Publication
(10) Pub. No.: US 2007/0181182 A1
(43) Pub. Date: Aug. 9, 2007

(54) Valve assembly

(75) Inventors: James H. Kralick, Albany, NY (US); Alexander Kagan, Guilderland, NY (US)

Correspondence Address: LARSON NEWMAN ABEL POLANSKY & WHITE, LLP, 5914 WEST COURTYARD DRIVE, SUITE 200, AUSTIN, TX, 78730, US

(73) Assignee: Intermagnetics General Corporation, Latham, NY (US)

(21) Appl. No.: 11/351,199

(22) Filed: Feb. 9, 2006

(51) Int. Cl. F16K 17/16

(52) U.S. Cl. 137/69

(57) ABSTRACT

A valve assembly can include a ruptureable member. The ruptureable member may be secured in place by a first support member, a second support member, and one or more removable engaging elements. The valve assembly can be configured such that the ruptureable member can be removed when a single removable engaging element is removed. In another embodiment, a valve assembly can include a plunger having a substantially solid shaft. The valve assembly can also include a ruptureable section attached to the substantially solid shaft. In still another embodiment, a valve assembly can include a plunger including a stem portion and a motion limiter portion, wherein the motion limiter portion is wider than the stem portion. The valve assembly can also include a spring surrounding the stem portion and the motion limiter portion, wherein the motion limiter portion is configured to keep the spring from becoming fully compressed.

### RELATED APPLICATION

The present disclosure is related to U.S. patent application No. ______ entitled “Housing and System and Method of Using the System” by Kralick filed on ______, 2006, which is assigned to the current assignee hereof and incorporated herein by reference in its entirety.

### BACKGROUND

1. Field of the Disclosure

The disclosure relates to valve assemblies, and more particularly to valve assemblies used in reducing pressure within a pressurized system.

2. Description of the Related Art

FIG. 1 includes a schematic diagram of a portion of a magnetic resonance imaging (“MRI”) system 100. The MRI system 100 includes a vessel 120 that can include a superconducting magnet (not illustrated). Typically at least a portion of the superconducting magnet is immersed in liquid helium. When an overpressure event occurs the pressure within the vessel 120 can be reduced by the valve assembly 140. The operation of the valve assembly 140 is described in more detail with respect to FIG. 2. The valve assembly 140 is attached to the vessel 120 with bolts 130, two of which are illustrated in FIG. 1.

An exhaust elbow 160 directs gas that passes through the valve assembly 140 to an exhaust. The exhaust elbow 160 includes a vent 164 that can be coupled to a portion (not illustrated) of the vessel 120. The exhaust elbow 160 can also include a drain 162 to drain any liquid that may accumulate within the exhaust elbow 160 adjacent to the valve assembly 140. The exhaust elbow 160 may be attached directly to the valve assembly 140 using bolts (not illustrated).

FIG. 2 includes a more detailed schematic drawing of the valve assembly 140 during operation of the MRI system 100. The valve assembly 140 includes a valve body 142, a spring 144, and a nut 146. The combination of the spring 144 and the nut 146 can be used to adjust the pressure at which the valve assembly 140 will open before the diaphragm 154 of the ruptured disk 152 is ruptured. The rupture disk 152 is held in place by a support ring 156 and bolts 158 that secure the support ring 156 to the valve body 142. Typically, six or more bolts 158 may be used to secure the support ring 156 to the valve body 142.

During normal operation, the valve body 142 is pressed against a plate 148 at an o-ring 150. For example, the vessel 120 may operate at a pressure of approximately 14 kPa (approximately 2 pounds per square inch or “psi”). When the pressure reaches approximately 28 kPa (approximately 4 psi), gas from the vessel 120 presses against the diaphragm 154 and opens up the valve assembly 140 to allow gases to flow through ports 159 within the valve body 142. As the pressure increases to approximately 66 kPa (approximately 9.6 psi), the diaphragm 154 can rupture and allow gas to flow through the rupture disk 152 that was previously sealed by diaphragm 154. The gas passes through the valve assembly 140 and the exhaust elbow 160 to the exhaust. In this manner, the valve assembly 140 can be used in substantially preventing the vessel 120 from reaching its maximum safe working pressure, which may be approximately 105 kPa (approximately 15 psi).

The spring 144 in the valve assembly 142 can have problems. The spring 144 has a relatively low spring constant. The valve assembly 142 produces a significant amount of chatter during operation due to the relatively low spring constant. The spring 144 is also susceptible to damage. During a pressure burst, the spring 144 may become fully compressed and potentially damage the spring 144 such that it will not have the same spring constant. As used in this specification, fully compressed is intended to mean that substantially all of the windings of a spring physically contact their adjacent windings.

Another issue with the valve assembly 142 is related to maintenance. Typically, the exhaust elbow 160 and the valve assembly 140 are removed from the vessel in order to perform routine maintenance on the valve assembly 140. When the valve assembly 140 is removed, an opening within the vessel 120 can allow a significant amount of the cryogen to escape as liquid, vapor, or a combination of liquid and vapor. Replacing lost cryogen can be costly and time consuming. If substantially all of the liquid cryogen is vaporized, air may enter the vessel 120, which is undesired. When the vessel 120 is taken to its cryogenic state, air within the vessel 120 may form ice. The ice can freeze components in place, not allow good thermal contacts to be made, mix with the liquid cryogen and form a slurry, result in another adverse consequence, or any combination thereof.

Routine maintenance may involve substantial disassembly of the valve assembly 140. For example, if the o-ring 150 is to be replaced, the nut 146 would be removed, and the valve body 142 when be removed from the plate 148. After a new o-ring 150 is installed, the valve assembly 140 may need to be recalibrated so that the valve assembly 140 opens at the designed pressure. Thus, replacing an o-ring can require recalibration of the valve.

Replacement of the rupture disk 152 may involve removing a plurality of the bolts 158, and potentially, all of the bolts 158. As the number of bolts needed to be removed increases, the maintenance costs increase as more time is used in removing and reattaching the bolts.

The exhaust elbow 160 is bolted in place, and therefore, allows substantially no ability to adjust it to another connection (not illustrated), such as the exhaust connection. Thus, a small change is in position of the vessel 120, the valve assembly 140, the exhaust elbow 160, or any combination thereof may make reconnecting the exhaust elbow 160 and the exhaust significantly more difficult.

### BRIEF DESCRIPTION OF THE DRAWINGS

The present disclosure may be better understood, and its numerous features and advantages made apparent to those skilled in the art by referencing the accompanying drawings.

FIG. 1 includes a schematic drawing of a valve assembly and an exhaust elbow.

(Prior Art)

FIG. 2 includes an enlarged schematic drawing of the valve assembly of FIG. 1.

(Prior Art)

FIG. 3 includes a schematic drawing of a system that includes a housing.

FIG. 4 includes an illustration of a perspective view of the housing of FIG. 3 and a valve assembly within the housing.

FIG. 5 includes an illustration of a cross-sectional view of the housing and valve assembly of FIG. 4.

FIG. 6 includes an illustration of an enlarged cross-sectional view of the valve assembly of FIG. 5.

FIG. 7 includes an illustration of a cross-sectional view of the housing of FIG. 5 without the valve assembly.

FIG. 8 includes an illustration of a perspective view of positional relationships between portions of the valve assembly and housing of FIG. 5.

FIGS. 9 and 10 include illustrations of side views of a housing in accordance with an alternative embodiment.

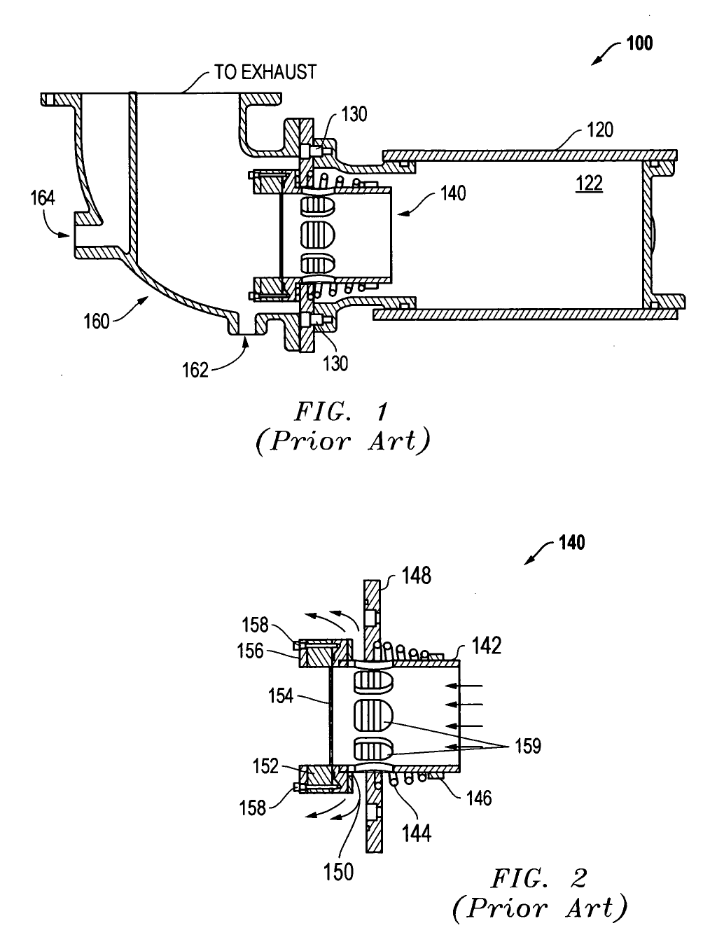

The use of the same reference symbols in different drawings indicates similar or identical items. Skilled artisans will appreciate that elements in the figures are illustrated for simplicity and clarity and have not necessarily been drawn to scale.

### DETAILED DESCRIPTION

A valve assembly can be used to reduce the likelihood of damaging a pressurized system. In one aspect, the valve assembly can include a ruptureable member. The ruptureable member may be secured in place by a first support member, a second support member, and one or more removable engaging elements. The valve assembly can be configured such that the ruptureable member can be removed when a single removable engaging element is removed. In another aspect, a valve assembly can include a plunger having a substantially solid shaft. The valve assembly can also include a ruptureable section attached to the substantially solid shaft. In still another aspect, a valve assembly can include a plunger including a stem portion and a motion limiter portion, wherein the motion limiter portion is wider than the stem portion. The valve assembly can also include a spring surrounding the stem portion and the motion limiter portion, wherein the motion limiter portion is configured to keep the spring from becoming fully compressed. The valve assembly may help to simplify maintenance or other servicing procedures, reduce valve chatter or other operational anomalies, reduce downtime, reduce costs, or any combination thereof. Exemplary, non-limiting valve assemblies are described in more detail later in this specification.

A few terms are defined or clarified to aid in understanding of the terms as used throughout this specification. The term “cracking pressure” is intended to mean a pressure at which a valve assembly reversibly opens or closes.

The term “directly visible,” when referring to an object, is intended to mean that such object can be seen by a human having at least normal or 20/20 vision, without the use of an optical aid (e.g., a mirror or other reflective surface, a telescope, a microscope, a camera, or the like).

The term “joining” is intended to mean bringing two or more objects in close proximity to each other so that the two or more objects touch or almost touch each other. After two or more objects are joined, they may or may not be attached, connected, fastened, or otherwise secured to each other.

The term “removable engaging element” is intended to mean an object that can be used to reversibly attach, connect, fasten, or otherwise secure two or more other objects together. An example of a removable engagement element can include a bolt, a screw, a nut, a band, a C-clamp, another suitable fastener, or any combination thereof.

Other than atmospheric pressure, all other pressures are specified as gauge pressures within this specification.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

Additionally, for clarity purposes and to give a general sense of the scope of the embodiments described herein, the use of the “a” or “an” are employed to describe one or more articles to which “a” or “an” refers. Therefore, the description should be read to include one or at least one whenever “a” or “an” is used, and the singular also includes the plural unless it is clear that the contrary is meant otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

To the extent not described herein, many details regarding specific materials, processing acts, and components, assemblies, and systems are conventional and may be found in textbooks and other sources within the superconducting, cryogenic, and medical device arts.

While much of the description herein is directed to an MRI system, after reading this specification, skilled artisans will appreciate that the concepts described herein may also be extended to a different system. In another embodiment, the system may include a superconductor in a different application (e.g., a transmission or distribution cable, a transformer, a fault current limiter, one or more other suitable electronic devices, or any combination thereof), a cryogenic sub-system (e.g., an ion implanter, a mass spectrometer, a thin-film deposition tool, one or more other suitable low temperature or low pressure apparatuses, or any combination thereof), or any combination of a superconductor and a cryogenic sub-system. In still another embodiment, the system may be pressurized, such as a boiler. Also, the concepts described herein may be extended to another fluid system where a differential pressure across a valve assembly is not to exceed a predetermined amount. In one embodiment, a liquid may contact a valve assembly within the system. Thus, the systems and methods described herein are not limited only for use with an MRI system.

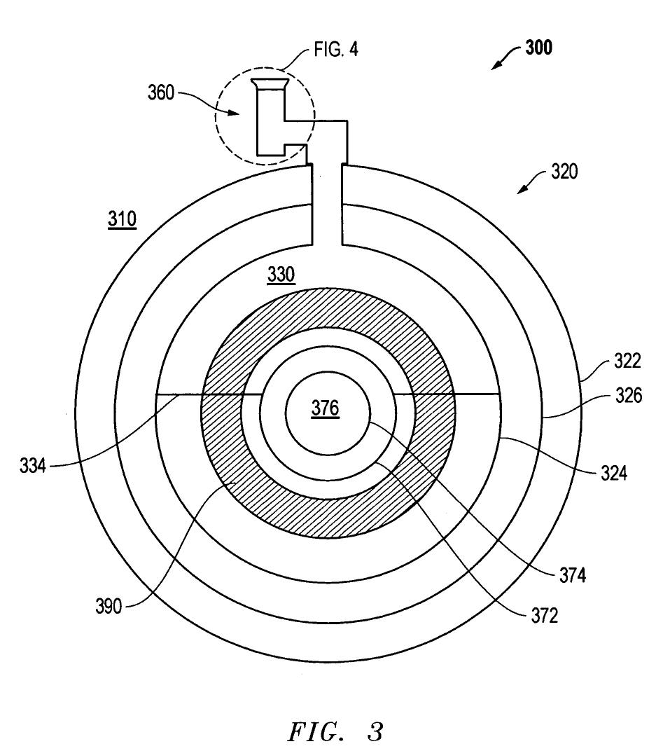

FIG. 3 includes a schematic drawing of a system 300. In one embodiment, the system 100 can be an MRI system. The system 100 includes a superconducting magnet 390 that is contained within a vessel 340. The vessel 340 includes a shell having an outer wall 322 and an inner wall 324. The outer wall 322 is exposed to an ambient 310 that includes air substantially at room temperature (approximately 295 to 305 K) and atmospheric pressure (approximately zero gauge pressure). An interior space 330 lies within the inner wall 324. A thermal shield 326 lies between the outer and inner walls 322 and 324. The vessel 320 can include another wall 372. The superconducting magnet 390 can be in its superconducting state by at least partial immersion of the superconducting magnet 390 within a bath of liquid cryogen (below line 370), typically helium. The system 300 can also include a patient wall 374 with a space 376 in which a patient (not illustrated) may be placed when using the system 300 during normal operation. To simplify understanding of the system, its components, and methods of using the system, some features that would be present within the system 300 are not illustrated. For example, an electrical feedthrough (through the walls of the vessel 320) to the superconducting magnet 390, a cryocooler, a temperature sensor, a pressure sensor, a pump, or any combination thereof may be present with system 300 but is not illustrated in the figures. After reading this specification, skilled artisans will understand that additional features may be present but are not illustrated.

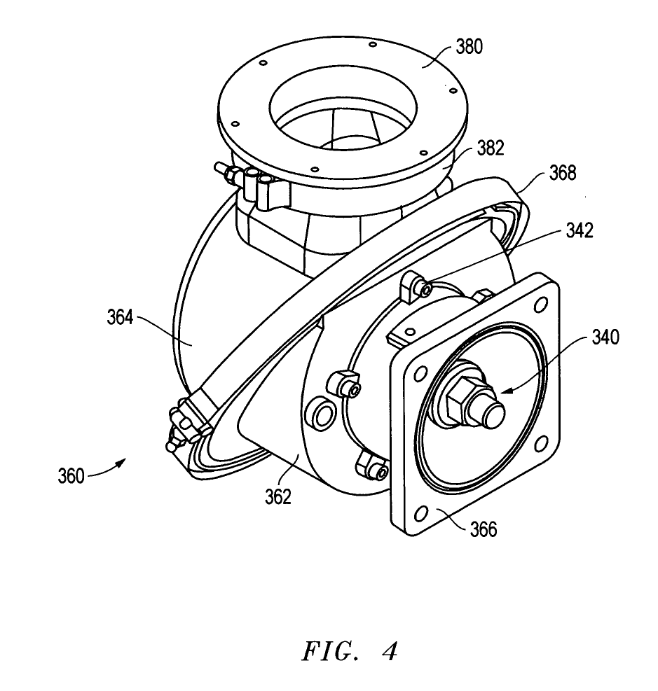

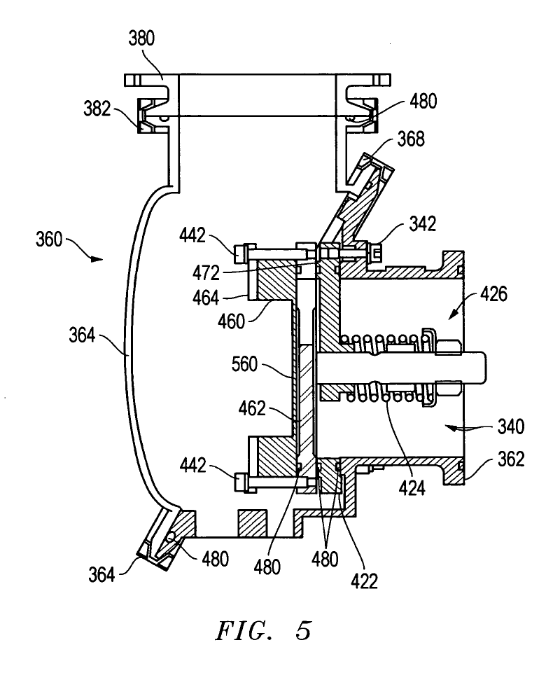

FIG. 4 includes an illustration of a perspective view of a housing 360, a valve assembly 340 disposed within the housing 360, and a flange 380 attached to the housing 360. In one embodiment, effluent from a vessel or other structure may be routed through the housing 360. In a particular embodiment, the housing 360 may be coupled to an exhaust system, a recirculation loop, a recovery system, or the like.

In one embodiment, the valve assembly 340 is attached to a housing member 362 of the housing 360 by removable engaging elements 342 are used to attach the valve assembly 340 to the housing member 362. In one embodiment, a removable engaging element 342 can include a bolt, a screw, a nut, another suitable fastener, or any combination thereof. The valve assembly 340 extends into an opening of the housing member 362 near a flange 366. The housing member 362 can be attached to the vessel 320 (not illustrated in FIG. 4) at the flange 366.

A band 368 can be used to join the housing member 362 and housing member 364 to one another. The combination of flanges of the housing members 362 and 364 and the band 368 allow rotation between the housing member 362 and 364 before the members are secured in place by tightening the band 368. Similarly, the housing member 364 is joined to the flange 380 using a band 382. The flange 380 and the housing member 364 can be rotated with respect to each other before being secured in place by tightening the band 382. The ability to rotate the housing members 362 and 364 relative to each other and the ability to rotate the housing member 364 and a flange 380 relative to each other allow for greater latitude one reassembling the system 300 after maintenance or other servicing. The bands 368 and 382 are examples of removable engaging elements.

FIG. 5 includes an illustration of a cross-sectional view of the valve assembly 340 and housing 360 to better illustrate relationships between components therein. The valve assembly 340 can be attached to the housing member 362 using the removable engaging elements 342, one of which is illustrated in FIG. 5. In one embodiment, the removable engaging elements 342 attach the valve body 422 of the valve assembly 342 to the housing member 362. In a particular embodiment, a removable engaging element 342 can include a bolt, a screw, a nut, another suitable fastener, or any combination thereof. The valve assembly 340 further includes a plunger 426 and a spring 424. The spring 424 has a relatively higher spring constant as compared to the spring 144. Thus, valve chatter during operation of the valve assembly 340 may be reduced or substantially eliminated as compared to valve chatter during operation of the valve assembly 142 in FIG. 1.

Referring to FIG. 5, removable engaging elements 442 help to secure a ruptureable member 460 in place. The ruptureable member 460 includes a ruptureable portion 560. The removable engaging elements 442 pass through a support member 464 (e.g., a support ring) and are attached to a support member 462, which is part of the plunger 426. Nearly any number of removable engaging elements 442 may be used. In one embodiment, four removable engaging elements 442 may be used to allow the ruptureable member 460 to be replaced. In another embodiment, three removable engaging elements 442 may be used. In either of these embodiments, as little as one removable engaging element 442 may be removed in order to replace the ruptureable member 460. In still another embodiment, not illustrated, as little as one removable engaging element may be used. For example, the removable engaging elements 442 could be replaced by a band, or the support member 464 may be attached to a hinge (not illustrated), and one removable engaging member may be used at a location opposite the hinge. After reading this specification, skilled artisans appreciate that still other configurations are possible. When a plurality of removable engaging elements is used, one or more of the other removable engaging elements 442 may be loosened to allow the ruptureable member 460 to be replaced more easily. After the ruptureable member 460 is replaced, the removable engaging element 442 that was removed can be inserted and tightened, and the remaining removable engaging elements 442 may be tightened as needed or desired. In another embodiment, more than four removable engaging elements 442 may be used.

The removable engaging elements 442 are a different set of removable engaging elements as compared to the removable engaging elements 342, which are used to attach the valve body 422 to the housing member 362. Such a design allows servicing of the ruptureable member 460 without having to remove the valve assembly 340 from the housing member 362.

FIG. 5 also includes several o-rings 480 that are used to help ensure the integrity of the seals being formed. Any of the o-rings 480 may be replaced by a gasket (not illustrated). To simplify understanding, references are made to o-rings, even through gaskets could be used. Many grooves, which are where the o-rings 480 lie or could lie, are illustrated in the figures. In other embodiments, the grooves could be extend from surfaces at corresponding locations of the objects being joined in conjunction with or in place of the grooves illustrated in the figures. For example, with respect to the o-ring 480 between the housing members 362 and 364, a groove extends from a surface of the housing member 362. In another embodiment, a groove having substantially the same dimensions could extend from the corresponding surface of the housing member 364 instead of the housing member 362. In still another embodiment, grooves could extend from the surfaces of the housing members 362 and 364. Similar modifications may be made for each of the other locations where grooves and o-rings 480 are used.

An interface 472 lies between the support member 462 and the valve body 422. In one embodiment, the interface 472 can be directly visible from the opening (adjacent to the flange 380) of the housing member 364. As will be described later, a more direct flow from the valve assembly 340 to the flange 380 can be achieved.

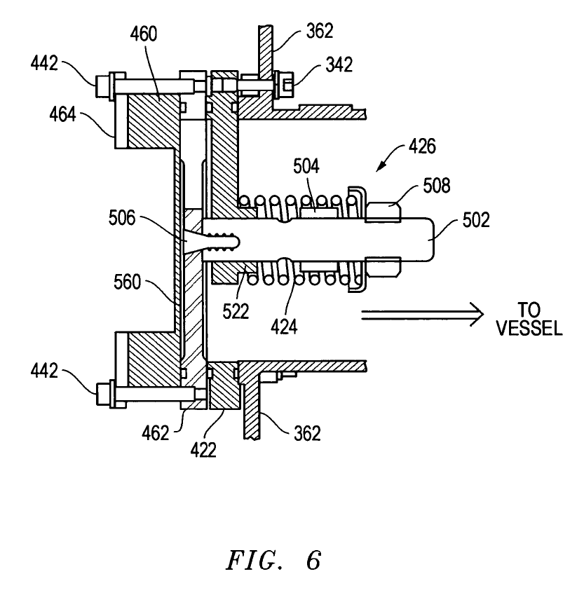

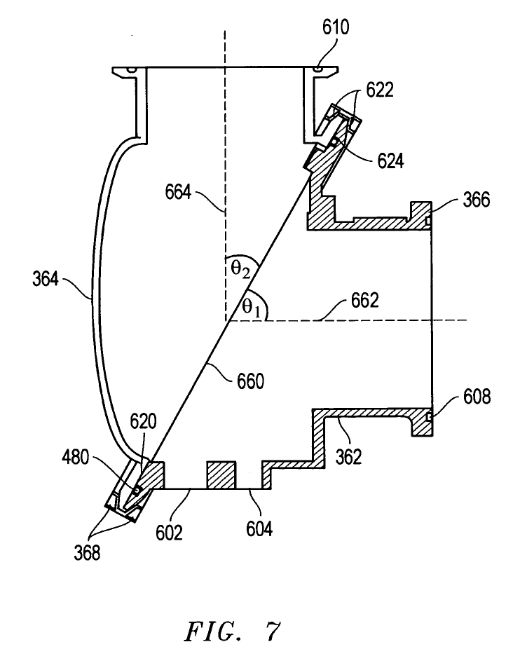

Other details and other features of the valve assembly 340 and the housing 360 are described in more detail in FIGS. 6 and 7, respectively.

FIG. 6 includes an illustration of an enlarged cross-sectional view of the valve assembly 340. The plunger 426 can include a stem portion 502, a motion limiter portion 504, the support member 462, and a removable engaging element 506. The stem portion 502 can include a substantially solid shaft that extends move through a guide 522 within the valve body 422 of the valve assembly 340. Although the length of the guide 522 is illustrated as being wider than the valve body 422, the guide 522 could have the same length or potentially could be even shorter than the width of the valve body 422. The guide 522 may be part of the valve body 422 (illustrated in FIG. 5) or may be a separate piece (not illustrated) that is attached to the valve body 422. The guide 522 can help keep the motion of the plunger 426 relatively linear. More uniform pressure at the interface 472 may be achieved and can significantly reduce premature failure of the seal at the interface 472.

The springs 424 surrounds the substantially solid shaft of the stem portion 502, the motion limiter portion 504, and the guide 522, as illustrated in FIG. 5. The motion limiter portion 504 can contact the guide 522 when the pressure change is relatively quick (i.e., a pressure burst) and occur before the ruptureable portion 560 ruptures. Thus, the motion limiter portion 504 can help to reduce the likelihood that the spring 424 would become fully compressed and damaged during a pressure burst.

The cracking pressure of the valve assembly 340 can be adjusted by turning a nut 508. As the nut 508 is tightened, the cracking pressure will increase, and as the nut 508 is loosened, the cracking pressure will decrease. After reading this specification, skilled artisans will be able to determine and set the cracking pressure.

The ruptureable member 460 also includes the ruptureable portion 560, as illustrated in FIG. 6. The ruptureable portion 560 can be designed to rupture at a pressure no greater than the highest safe working pressure or the maximum designed pressure of the vessel 320. The ruptureable portion 560 may also be designed to rupture at a pressure no less than the highest normal operating pressure, the cracking pressure, or any combination thereof. The ruptureable portion 560 can include a diaphragm having a material of a substantially uniform thickness such that the ruptureable portion 560 will rupture before the vessel 120 reaches too high of a pressure. In another embodiment, the ruptureable portion 560 may include a material having a perforation, a locally thinner area, or any combination thereof that can help the ruptureable portion 560 to rupture at the perforation, locally thinner area, or any combination thereof.

Pressures used for operation and pressures used in designing components of the system 300 are described in more detail in this specification when addressing operation of the system 300.

FIG. 7 includes an illustration of a cross-sectional view of the housing 360, without the valve assembly 340, to improve understanding of positional and other relationships between different parts of the housing 360. The housing member 362 includes a vent 602 that is similar to the vent 164 in FIG. 1 in that vent 602 can be coupled to the vessel 320 (not illustrated). A drain 604 can be used to drain liquids that may accumulate within the housing 340. The housing member 362 includes a groove 608 where an o-ring may be placed before attaching the housing member 362 to the vessel 320. The housing member 362 also includes a groove 624 in which an o-ring 480 lies. The housing member 364 includes a groove 610 where an o-ring may be placed before attaching the housing member 364 to the flange 380 (not illustrated in FIG. 7).

The housing members 362 and 364 can be joined together near surfaces 620. The housing member 364 may be rotated with respect to housing member 362, or vice versa. After the housing members 362 and 364 are in their desired positions with respect to each other, the band 368 can be tightened to secure the housing members 362 and 364 together. Band 368 can include a complementary cross-sectional shape to receive the beveled portions 622. In one embodiment, the band 368 includes a V-band that contacts the housing members 362 and 364 along beveled portions 622 of the housing members 362 and 364. As the band 368 is tightened, the o-ring 480 can be compressed in order to ensure a good seal between the housing members 362 and 364. In another embodiment, the band 368 may be replaced by or used in conjunction with a C-clamp, a jig, another suitable securing device, or any combination thereof.

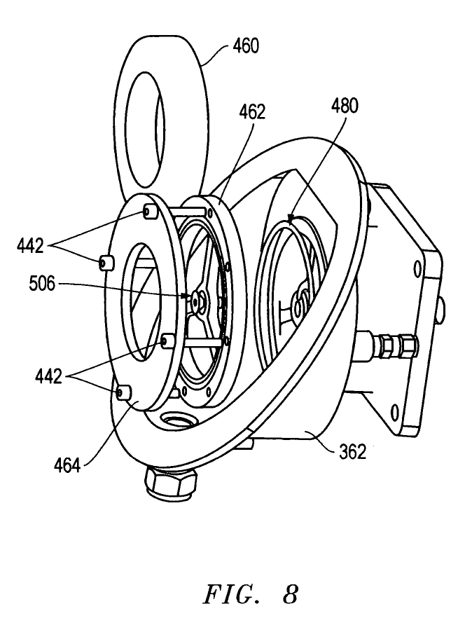

The surfaces 620 lie substantially along a plane 660. A centerline 662 extends through a center point of an opening within the housing member 362, wherein the opening extends to the flange 366. Another centerline 664 extends through a center point through an opening within the housing member 364, wherein the opening lies adjacent to the exhaust flange 380 (not illustrated in FIG. 7). In one embodiment, the centerline 664 intersects the centerline 662 at an angle in a range of approximately 50° to 150°, and in a particular embodiment, the centerline 664 is substantially perpendicular to the centerline 662. The centerline 662 intersects the plane 660 at an angle θ₁, and the centerline 664 intersects the plane 660 at an angle θ₂. Each of the angles θ₁ and θ₂ is an acute angle. In one embodiment, a sum of θ₁ and θ₂ is substantially 90°, and thus, θ₁ and θ₂ are complementary angles. In a particular embodiment, each of θ₁ and θ₂ may be in a range of approximately 10° to 80°, and in a more particular embodiment, in a range of approximately 30° to 60°. The significance of the surfaces 620 lying substantially along plane 660 will become more apparent when describing a method of servicing the system as described in more detail in FIG. 8.

A method of using the system 300 is described with respect to FIG. 5. Note that the system 300 can include a nearly any pressurized vessel where the pressure inside the vessel is higher than the pressure within the housing 360. As pressure within the vessel increases, a force is exerted against the ruptureable member 460. After the cracking pressure is reached, the plunger 426 will move and the spring 424 will become compressed. At this point, a gap will form along the interface 472 and allow gas to pass the surfaces at the interface 472 and exhaust into the housing member 364, through the flange 380 to the exhaust system. If the pressure is further increased, the ruptureable member 460 may rupture at the ruptureable portion 560.

Regarding pressures, the vessel 320 may be designed to normally operate at a pressure in a range of approximately 7 to 21 kilopascals (approximately 1 to 3 psi). Still, higher pressures may be experienced. Thus, the valve assembly 340 is designed to reduce the pressure within the vessel 320 before the vessel 320 is damaged.

The ruptureable member 460 can be designed to rupture at a pressure lower than the highest safe working pressure or maximum designed pressure for the vessel 320. In one embodiment, the vessel 320 may be allowed to reach a pressure of approximately 104 kPa (approximately 15 psi), and therefore the ruptureable member 460 can be designed to rupture at a pressure no greater than that amount. In a particular embodiment, the ruptureable member may be designed to rupture at a pressure in a range of approximately 60 to 70 kPa (approximately 9 to 10 psi).

The cracking pressure may be higher than the normal operating pressure of the vessel 320 and lower than the pressure that would otherwise rupture the ruptureable member 460. In one embodiment, the cracking pressure may be in a range of approximately 21 to 60 kPa (approximately 3 to 9 psi). In a particular embodiment, the cracking pressure may be in a range of approximately 21 to 35 kilopascals (approximately 3 to 5 psi). After reading this specification, skilled artisans will appreciate that other pressures may be used for the vessel 320, the rupturing pressure for the ruptureable portion 460, the cracking pressure, or any combination thereof. Therefore, the valve 340 has a design that is flexible in order to achieve its proper operation for a wide variety of different pressures and pressure ranges.

The combination of the housing 360 and the valve assembly 340 allows for relatively easier service, particularly when the ruptureable member 460 is to be replaced. Servicing of the ruptureable member 460 will be described with respect to FIGS. 5 and 8. In a particular embodiment, the ruptureable member 460 may have its ruptureable portion 560 ruptured during a pressure burst within the vessel 320. The pressure within the vessel 320 may then be taken to its normal operating pressure or to a lower pressure in order for the service to be performed. The band 368 may be loosened and removed along with the housing member 364. In one embodiment, the attachment to the flange 380 or exhaust line (not illustrated) do not need to be broken. The angle at the joining surfaces of the housing members 362 and 364 allow relatively easy access to the ruptureable member 460. When the housing member 364 is removed, the ruptureable portion 560 is directly visible, even while the valve assembly 340 remains attached to the housing member 362.

In one embodiment, one of the removable engaging elements 442, such as the removable engaging element 442 closest to the top of FIG. 8 may be removed. One or more of the other removable engaging elements 442 may be loosened to allow the ruptureable member 460 to be pulled away from the support members 462 and 464. A new ruptureable member, which may be substantially identical to the ruptureable member 460 prior to having its ruptureable portion ruptured, may be inserted between the support members 462 and 464. The use of the removable engaging elements 442 that remain (i.e., not removed) may help to align the ruptureable member 460 to its proper position than if all removable engaging elements 442 were removed. The top-most removable engaging element 442 can then be reinserted and tightened. One or more of the other removable engaging elements 442 may be re-tightened to secure the ruptureable member 460 in place. As little as one removable engaging element 442 may be removed to replace the ruptureable member 460, and thus, servicing time may be reduced. The use of three removable engaging elements, rather than the four removable engaging elements as illustrated, can achieve a similar result.

In another embodiment, the o-ring 480 as illustrated in FIG. 8 may need to be routinely maintained, replaced, or otherwise serviced. In this embodiment, the ruptureable member 460 may be removed as previously described. At this point in the process, the removable engaging element 506 may be removed to allow access to the o-ring 480. The o-ring 480 may be serviced or replaced. The support member 462 can then be attached to the stem 502 using the removable engaging element 506. The ruptureable member 460 may be reinserted or a new ruptureable member may be used instead. The ruptureable member can then be secured in place as previously described. The housing members 362 and 364 may then be joined, and the band 368 may be placed around the beveled portions of the housing members 362 and 364 to reduce the likelihood that the housing member 364 will fall off during subsequent positioning. After the housing member 364 is positioned into its correct position, the band 368 may be tightened to substantially prevent further movement of the housing member 364.

The servicing procedures can be beneficial to users of the system 300. The use of the housing members 362 and 364 allow easier service access to the valve assembly 340 without having to remove all of the housing 360 and valve assembly 340 from the vessel 320. Compare the housing 360 and valve assembly 340, as described, to the exhaust elbow 160 and the valve assembly 140 in FIG. 1. When the exhaust elbow 160 and the valve assembly 140 are removed in FIG. 1, a relatively large opening exists from which cryogenic vapor within the vessel can escape and for air to enter into the vessel. In an embodiment where a cryogen is used, a significance amount of the cryogen in may be lost and will need to be replaced. In another embodiment, if all of the liquid cryogen would be vaporized, air from outside of the vessel may enter the vessel and cause a quench event, boil off the liquid cryogen, result in an overpressure condition, damage the system, additional downtime or costs, or any combination thereof.

In addition, the air could cause ice to form within the vessel, which for a cryogenic system could cause restricted movement of parts, reducing thermal contact between different parts of the system that may need thermal contact, freezing together parts that should not be frozen together, forming a slurry of the ice and liquid cryogen, another undesired consequence, or any combination thereof. When the ruptureable member 460 is replaced, a significantly smaller opening to the vessel 320 is formed. In addition, the ruptureable member 460 can be replaced significantly faster as compared to replacing the rupture disk 152 in the system 100 illustrated in FIG. 1. Thus, the housing 360 and the valve assembly 340 can significantly reduce an undesired consequence, downtime, costs, or any combination thereof as compared to using the system 100 as illustrated in FIG. 1.

Another benefit can occur when the valve assembly 340 is removed from the vessel 320. The valve assembly 340 can be removed using the removable engaging elements 342 and does not require disturbing the spring 424 or the nut 508. Thus, recalibration of the cracking pressure for the valve assembly 340 is less likely to be required when only removing the valve assembly 340, as compared removing to the valve assembly 140 in FIG. 1. Service can be performed on the valve assembly 340 without significantly changing the compression of the spring 424. Therefore, the valve assembly 340 may be removed and reattached with a reduced likelihood of significantly changing the cracking pressure.

Another benefit is that the interface 472 (exposed when the cracking pressure is reached) may be visible from the outlet opening (adjacent to the flange 380) of the housing member 364. In one embodiment, a portion of the gas or other fluid flows past the surface of the valve body 422 after the valve assembly 340 opens at the interface 472 (near the top of FIG. 5). The portion may travel travels along a path from a surface of the valve body 422 to the opening of the housing member 364 that is connected to the flange 380. The path is substantially parallel to a centerline for the opening in the housing member 364. Thus, the path may not include any bending. Another portion of the gas or other fluid may flow in another direction and may bend before reaching the opening in the housing member 364. Thus, this other portion of travels along a different path from the surface of the valve body 422 to the opening of the housing member 364, wherein the different path is not parallel to the centerline. The pressure drop within the housing 360 may be less as compared to the pressure drop within the exhaust elbow 160 in FIG. 1. When the valve assembly 140 in FIG. 1 opens (after reaching the cracking pressure), the gas will need to bend and twist in the exhaust elbow 160 before it exits to the exhaust. The reduced amount of bending of gas flowing in the system 300 may be beneficial to reduce pressure loss and allow the gas to more easily escape during an overpressure event and potentially reduce the likelihood of the ruptureable portion 560 rupturing during an overpressure event.

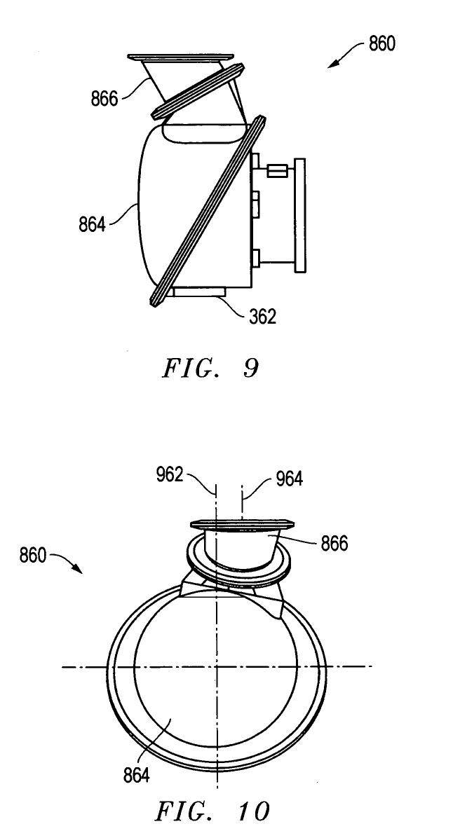

FIGS. 9 and 10 include side views of an alternative housing 860. The housing 860 includes housing member 362, as previously described. The housing member 364 in FIG. 4 is replaced by housing members 864 and 866. The housing members 866 and 864 have surfaces that lie along a plane which allow rotation of housing members 864 and 866 with respect to each other. The housing 860 allows more freedom in aligning the exhaust connection (not illustrated) to the housing 860. In addition to allowing rotation between housing members 864 and 866, the housing members 362 and 864 may also be rotated with respect to each other. In this manner, an offset between a centerline 962 of the opening within the housing member 362 and a centerline 964 of the opening of the housing member 866 will not pose a problem when attaching an exhaust line (not illustrated) to the housing 860. If the exhaust line or the vessel 320 (not illustrated in FIGS. 9 and 10) would be moved, an adjustment in the position of the housing member 362, 864, 866, or any combination thereof can be made an order to make the proper connection without having to significantly move the exhaust line or the vessel 320. The three housing members in housing 860 allow more flexibility in making connections and also allow making the connections after servicing easier with respect to lining the exhaust to the housing.

In an alternative embodiment (not illustrated), the valve assembly 340 may be attached to the vessel rather than the housing member 362. The valve assembly 340, substantially all or a portion thereof, may still be disposed within the housing 340.

Many different aspects and embodiments are possible. Some of those aspects and embodiments are described below. After reading this specification, skilled artisans will appreciate that those aspects and embodiments are only illustrative and do not limit the scope of the present invention.

In a first aspect, a valve assembly can include a ruptureable member including a ruptureable portion that is designed to rupture before a pressure difference across the ruptureable portion exceeds a predetermined value, wherein the ruptureable member includes a first side and second side opposite the first side. The valve assembly can also include a first support member and a second support member, wherein the first support member lies along the first side of the ruptureable member, and the second support member lies along the second side of the ruptureable member. The valve assembly can further include a first removable engaging element adjacent to ruptureable member. The removable engaging elements may lie outside a perimeter of the ruptureable member.

In one embodiment of the first aspect, the valve assembly can further include an additional removable engaging element, wherein a plurality of the removable engaging elements includes the first removable engaging element and the additional removable engaging element, wherein the valve assembly is configured such that the ruptureable member can be removed when a single removable engaging element of the plurality of removable engaging elements is removed. In another embodiment, the valve assembly can include no more than four removable engaging elements. In a particular embodiment, the valve assembly may include at least three removable engaging elements. In another embodiment, the valve assembly can further include a substantially solid shaft, wherein the first support member is attached to a substantially solid shaft. In a particular embodiment, the valve assembly can further include a spring, wherein the valve assembly is configured such that the first support member can be removed from the substantially solid shaft without removing the spring from the valve assembly.

In a further embodiment of the first aspect, the valve assembly can be configured to have a cracking pressure no greater than approximately 66 kPa, and the determined pressure no greater than approximately 104 kPa. In a particular embodiment, each of the cracking pressure and the rupture pressure is at least approximately 21 kPa. In another further embodiment, the removable engaging elements can include a bolt, a screw, or any combination thereof. In yet another embodiment, a system can including a vessel including a superconducting magnet and the valve assembly in accordance with any embodiments described herein. The valve assembly can be configured to maintain an internal pressure within the vessel less than a predetermined value.

In a second aspect, a valve assembly can include a plunger including a substantially solid shaft and a ruptureable section attached to the substantially solid shaft.

In one embodiment of the second aspect, the valve assembly can further include a screw or a bolt, wherein the screw or the bolt attaches the ruptureable section to the substantially solid shaft. In another embodiment, the ruptureable section can include a ruptureable member, a first support member, and a second support member. The first support member may lie along the first side of the ruptureable member, the second support member may lie along the second side of the ruptureable member, and the first support member can be attached to the substantially solid shaft. In a particular embodiment, the ruptureable section can further include no more than four removable engaging elements that pass through the first support member or the second support member and lie adjacent to a perimeter of the ruptureable member.

In still another embodiment of the second aspect, the valve assembly can further include a spring, wherein the valve assembly is configured such that the ruptureable section can be removed from the substantially solid shaft without significantly changing a compression of the spring. In yet another embodiment, the valve assembly can further include a guide, wherein the substantially solid shaft extends through the guide. In a particular embodiment, the valve assembly can further include an o-ring or a gasket, wherein the guide is attached to or part of a valve body that includes a groove, and wherein the o-ring or the gasket lies within the groove. In another particular embodiment, the valve assembly can further include a spring, wherein the plunger includes a motion limiter portion, and the spring surrounds the motion limiter portion, the substantially solid shaft, and the guide. In a further embodiment of the second aspect, a system can include a vessel including a superconducting magnet and the valve assembly in accordance with any embodiments described herein. The valve assembly can be configured to maintain an internal pressure within the vessel less than a predetermined value.

In a third aspect, a valve assembly can include a plunger including a stem portion and a motion limiter portion, wherein the motion limiter portion is wider than the stem portion. The valve assembly can also include a spring surrounding the stem portion and the motion limiter portion, wherein the motion limiter portion is configured to keep the spring from becoming fully compressed.

In one embodiment of the third aspect, the valve assembly can further include a guide, wherein the substantially solid shaft extends through the guide. In a particular embodiment, the valve assembly can further include an o-ring or a gasket, wherein the guide is attached to or part of a valve body that includes a groove, and wherein the o-ring or the gasket lies within the groove.

In another embodiment of the third aspect, the valve assembly can further include a ruptureable member and a first support member. The plunger can further include a second support member attached to the stem portion of the plunger. The first support member may lie along the first side of the ruptureable member, and the second support member may lie along the second side of the ruptureable member. In a particular embodiment, the valve assembly can further include no more than four removable engaging elements that pass through the first support member or the second support member and lie adjacent to a perimeter of the ruptureable member. In another particular embodiment, the valve assembly can be configured such that the ruptureable member, the first support member, and the second support member can be removed from the stem portion of the plunger without significantly changing a compression of the spring.

In still another embodiment of the third aspect, the valve assembly can further include a guide, wherein the stem portion extends through the guide, and wherein the valve assembly is configured such that the motion limiter portion can contact the guide before the spring would become fully compressed. In a further embodiment, a system can include a vessel including a superconducting magnet and the valve assembly in accordance with any embodiments described herein. The valve assembly can be configured to keep an internal pressure within the vessel from exceeding a predetermined value.

Note that not all of the activities described above in the general description or the examples are required, that a portion of a specific activity may not be required, and that one or more further activities may be performed in addition to those described. Still further, the order in which activities are listed is not necessarily the order in which they are performed.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that a structural substitution, logical substitution, or another change may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed subject matter requires more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

It is to be appreciated that certain features are, for clarity, described herein in the context of separate embodiments, may also be provided in combination in a single embodiment. Conversely, various features that are, for brevity, described in the context of a single embodiment, may also be provided separately or in any subcombination. Further, reference to values stated in ranges includes each and every value within that range.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A valve assembly comprising:
a ruptureable member including a ruptureable portion that is designed to rupture before a pressure difference across the ruptureable portion exceeds a predetermined value, wherein the ruptureable member includes a first side and second side opposite the first side;
a first support member and a second support member, wherein:
the first support member lies along the first side of the ruptureable member; and
the second support member lies along the second side of the ruptureable member; and
a first removable engaging element adjacent to ruptureable member, wherein the first removable engaging element lies outside a perimeter of the ruptureable member.

2. The valve assembly of claim 1, further comprising an additional removable engaging element, wherein a plurality of the removable engaging elements includes the first removable engaging element and the additional removable engaging element, wherein the valve assembly is configured such that the ruptureable member can be removed when a single removable engaging element of the plurality of removable engaging elements is removed.

3. The valve assembly of claim 1, further comprising a substantially solid shaft, wherein the first support member is attached to a substantially solid shaft.

4. The valve assembly of claim 3, further comprising a spring, wherein the valve assembly is configured such that the first support member can be removed from the substantially solid shaft without removing the spring from the valve assembly.

5. The valve assembly of claim 1, wherein:
the valve assembly is configured to have a cracking pressure no greater than approximately 66 kPa; and
a predetermined pressure no greater than approximately 104 kPa.

6. The valve assembly of claim 5, wherein each of the cracking pressure and the rupture pressure is at least approximately 21 kPa.

7. A system comprising:
a vessel including a superconducting magnet; and
the valve assembly of claim 1, wherein the valve assembly is configured to maintain an internal pressure within the vessel less than a predetermined value.

8. A valve assembly comprising:
a plunger including a substantially solid shaft; and
a ruptureable section attached to the substantially solid shaft.

9. The valve assembly of claim 8, further comprising a screw or a bolt, wherein the screw or the bolt attaches the ruptureable section to the substantially solid shaft.

10. The valve assembly of claim 8, wherein the ruptureable section comprises:
a ruptureable member:
a first support member and a second support member, wherein:
the first support member lies along the first side of the ruptureable member;
the second support member lies along the second side of the ruptureable member; and
the first support member is attached to the substantially solid shaft.

11. The valve assembly of claim 8, further comprising a spring, wherein the valve assembly is configured such that the ruptureable section can be removed from the substantially solid shaft without significantly changing a compression of the spring.

12. The valve assembly of claim 8, further comprising a guide, wherein the substantially solid shaft extends through the guide.

13. The valve assembly of claim 12, further comprising an o-ring or a gasket, wherein the guide is attached to or part of a valve body that includes a groove, and wherein the o-ring or the gasket lies within the groove.

14. The valve assembly of claim 12, further comprising a spring, wherein:
the plunger includes a motion limiter portion; and
the spring surrounds the motion limiter portion, the substantially solid shaft, and the guide.

15. A system comprising:
a vessel including a superconducting magnet; and
the valve assembly of claim 8, wherein the valve assembly is configured to maintain a pressure within the vessel from exceeding a predetermined value.

16. A valve assembly comprising:
a plunger including a stem portion and a motion limiter portion, wherein the motion limiter portion is wider than the stem portion; and
a spring surrounding the stem portion and the motion limiter portion, wherein the motion limiter portion is configured to keep the spring from becoming fully compressed.

17. The valve assembly of claim 16, further comprising a guide, wherein the substantially solid shaft extends through the guide.

18. The valve assembly of claim 17, further comprising an o-ring or a gasket, wherein the guide is attached to or part of a valve body that includes a groove, and wherein the o-ring or the gasket lies within the groove.

19. The valve assembly of claim 16, further comprising a ruptureable member and a first support member, wherein:
the plunger further comprises a second support member attached to the stem portion of the plunger;
the first support member lies along the first side of the ruptureable member; and
the second support member lies along the second side of the ruptureable member.

20. The valve assembly of claim 19, wherein the valve assembly is configured such that the ruptureable member, the first support member, and the second support member can be removed from the stem portion of the plunger without significantly changing a compression of the spring.

21. The valve assembly of claim 16, further comprising a guide, wherein the stem portion extends through the guide, and wherein the valve assembly is configured such that the motion limiter portion can contact the guide before the spring would become fully compressed.

22. A system comprising:
a vessel including a superconducting magnet; and
the valve assembly of claim 16, wherein the valve assembly is configured to keep a pressure within the vessel from exceeding a predetermined value.
